(19) United States
(12) Patent Application Publication
(10) Pub. No.: US 2012/0191468 A1
(43) Pub. Date: Jul. 26, 2012

(54) Apparatuses, Systems, and Methods for Detecting Healthcare Fraud and Abuse

(76) Inventor: Joseph Blue, St. Paul, MN (US)

(21) Appl. No.: 13/355,018

(22) Filed: Jan. 20, 2012

Related U.S. Application Data
(60) Provisional application No. 61/435,013, filed on Jan. 21, 2011.

(51) Int. Cl. G06Q 50/22; G06Q 40/08

(52) U.S. Cl. 705/2

(57) ABSTRACT

Methods, systems, and apparatuses are disclosed for identifying healthcare claim fraud. In some embodiments, the methods may include defining links characterizing an interaction between a healthcare consumer and a healthcare provider. In some embodiments, the methods may further include generating, with a processing device, an archive of the links. Additionally, in some embodiments, the methods may include analyzing the archive to identify potential healthcare fraud. In some embodiments, analyzing the archive may include defining one or more patterns indicative of fraud and searching for the one or more patterns indicative of fraud within the archive.

### CROSS-REFERENCE TO RELATED APPLICATIONS

This application claims the benefit of U.S. Provisional Application No. 61/435,013 filed Jan. 21, 2011, which is incorporated herein by reference in its entirety. The entire disclosures of U.S. Provisional Application No. 61/345,370 filed May 17, 2010, and U.S. patent application Ser. No. 13/108,696 filed May 16, 2011, are also incorporated herein by reference.

### BACKGROUND OF THE INVENTION

1. Field of the Invention

This invention relates to health related data analysis and more particularly relates to systems and methods for fraud detection.

2. Description of the Related Art

According to the Center for Medicare and Medicaid Services (CMS—formerly the Health Care Financing Administration (HCFA)), annual healthcare expenditures in the United States totaled over $1.4 trillion dollars in 2001, and are expected to increase 6.5% a year. Of this amount, a significant percentage is paid on fraudulent or abusive claims, though the amount lost to healthcare fraud and abuse can never be quantified to the dollar. In May 1992, U.S. General Accounting Office (GAO) reported that the loss amounted to as much as 10% of the nation's total annual healthcare expenditure, approximately $84 billion. A July 1997 audit of annual Medicare payments by the Inspector General found that approximately 14 percent of Medicare payments (about $23.2 billion) made in fiscal year 1996 was improperly paid, due to fraud, abuse, and the lack of medical documentation to support claims. Many private insurers estimate the proportion of healthcare dollars lost to fraud to be in the range of 3-5%, which amounts to roughly $30-$50 billion, annually. It is widely accepted that losses due to fraud and abuse are an enormous drain on both the public and private healthcare systems.

Health insurance companies typically maintain databases of health insurance claim information, geographic information, demographic information, and other data about health insurance plan members. Unfortunately, typical methods for analyzing such data and detecting fraud are often cumbersome, pricey, and require unworkably high processing times and resources.

### SUMMARY OF THE INVENTION

Methods, systems, and computer program products for identifying healthcare claim fraud are disclosed. In some embodiments, the method for identifying healthcare claim fraud may include defining links characterizing an interaction between a healthcare consumer and a healthcare provider. In some embodiments, the method may further include generating, with a processing device, an archive of the links. In some embodiments, the method may also include analyzing the archive to identify potential healthcare fraud. Analyzing the archive to identify potential healthcare fraud may include defining one or more patterns indicative of fraud and/or searching for the one or more patterns indicative of fraud within the archive.

In some embodiments, a link may comprise a first consumer-provider identity, a second consumer-provider identity, and/or a time. In some embodiments, the first consumer-provider identify is different from the second consumer-provider identity. In some embodiments, the links may include first-order links and second-order links. In some embodiments, the links may further include third-order links, and may even include Nth-order links.

In some embodiments, analyzing the archive further may include flagging known fraudsters. In some embodiments, analyzing the archive further may include heightened analysis of the links associated with flagged known fraudsters.

In some embodiments, the method may further include receiving a provider index and a patient index before defining the links. In some embodiments, the provider index may include provider handle keys and the patient index comprises patient handle keys. In some embodiments, receiving the provider index and patient index further comprises fuzzy matching.

In some embodiments, the one or more patterns are user-defined. In some embodiments, the one or more patterns are user-defined in response to clinical data.

Systems to identify healthcare claim fraud are also disclosed. In some embodiments, the system may include a data storage device configured to store a database comprising a patient index and a provider index. In some embodiments, the system may further include a server in data communication with the data storage device. In some embodiments, the server may be configured to execute one or more embodiments of the disclosed methods.

In some embodiments, the server may be configured to define links. In some embodiments, the server may be configured to generate an archive in response to the links. In some embodiments, the server may be configured to analyze the archive to identify potential healthcare fraud.

A computer program product for identifying fraud is also disclosed. In some embodiments, the computer program product may include a computer readable medium having computer usable program code executable to perform operations. These operations may include various embodiments of the disclosed methods.

In some embodiments, the computer program product may be configured to define links. In some embodiments, the computer program product may be configured to generate an archive in response to the links. In some embodiments, the computer program product may be configured to analyze the archive to identify potential healthcare fraud.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for detecting healthcare claim fraud;

FIG. 2 is a schematic block diagram illustrating one embodiment of a database system for detecting healthcare claim fraud;

FIG. 3 is a schematic block diagram illustrating one embodiment of a computer system that may be used in accordance with certain embodiments of the system for detecting healthcare claim fraud;

FIG. 4 is a schematic logical diagram illustrating one embodiment of abstraction layers of operation in a system for detecting healthcare claim fraud;

FIG. 5 is a schematic block diagram illustrating one embodiment of an apparatus for detecting healthcare claim fraud;

FIG. 6 is a schematic flow chart diagram illustrating an embodiment of a method for detecting healthcare claim fraud;

FIG. 7 is one embodiment of a pattern exemplifying first and second order links;

FIG. 8 is one embodiment of a pattern exemplifying healthcare claim fraud;

FIG. 9 is an additional embodiment of a pattern exemplifying healthcare claim fraud;

FIG. 10 is an additional embodiment of analyzing known fraudsters; and

FIG. 11 is an additional embodiment of a pattern exemplifying healthcare claim fraud.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules, in order to more particularly emphasize their implementation independence. A module is “[a] self-contained hardware or software component that interacts with a larger system.” Alan Freedman, “The Computer Glossary” 268 (8th ed. 1998). A module comprises a machine or machines executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions which may be organized as an object, procedure, or function. Nevertheless, the executables of an identified module need not be physically located together, but may comprise disparate instructions stored in different locations which, when joined logically together, comprise the module, and when executed by the processor, achieve the stated data transformation.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

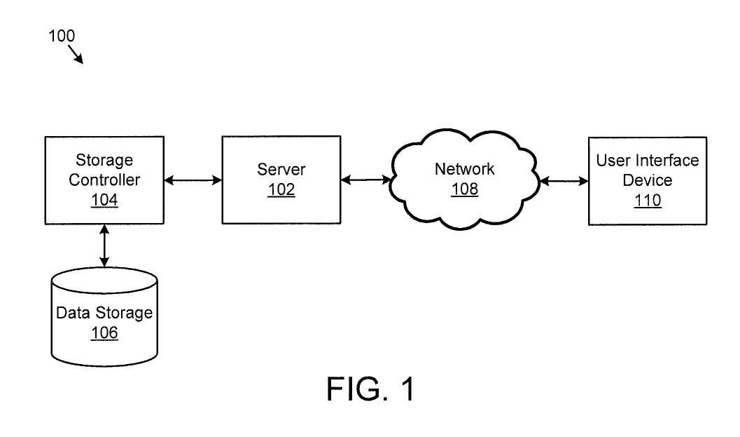

FIG. 1 illustrates one embodiment of a system 100 for detecting healthcare claim fraud. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may detect healthcare claim fraud. Specifically, the system 100 may comprise one or more modules to define links characterizing an interaction between a healthcare consumer and a healthcare provider, generate an archive of the links, and analyze the archive to identify potential healthcare fraud.

In one embodiment, the user interface device 110 is referred to broadly and is intended to encompass a suitable processor-based device such as a desktop computer, a laptop computer, a Personal Digital Assistant (PDA), a mobile communication device or organizer device having access to the network 108. In a further embodiment, the user interface device 110 may access the Internet to access a web application or web service hosted by the server 102 and provides a user interface for enabling a user to enter or receive information. For example, the user may enter one or more patterns indicative of fraud, information regarding a particular healthcare consumer and/or healthcare provider, or healthcare claim information.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another. Additionally, the server may access data stored in the data storage device 104 via a Storage Area Network (SAN) connection, a LAN, a data bus, or the like.

The data storage device 104 may include a hard disk, including hard disks arranged in an Redundant Array of Independent Disks (RAID) array, a tape storage drive comprising a magnetic tape data storage device, an optical storage device, or the like. In one embodiment, the data storage device 104 may store health related data, such as insurance claims data, consumer data, or the like. The data may be arranged in a database and accessible through Structured Query Language (SQL) queries, or other data base query languages or operations.

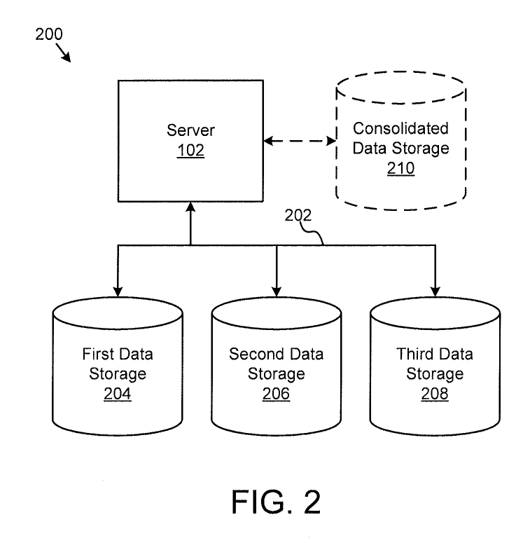

FIG. 2 illustrates one embodiment of a data management system 200 configured to store and manage data for identifying healthcare claim fraud. In one embodiment, the system 200 may include a server 102. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of healthcare claims, healthcare consumers, and healthcare providers. The customer information in each database may be keyed to a common field or identifier, such as an individual's name, social security number, customer number, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-208 to collect a consolidated set of data elements associated with an individual or group of individuals. The server 102 may store the consolidated data set in a consolidated data storage device 210. In such an embodiment, the server 102 may refer back to the consolidated data storage device 210 to obtain a set of data elements associated with a specified individual. Alternatively, the server 102 may query each of the data storage devices 204-208 independently or in a distributed query to obtain the set of data elements associated with a specified individual. In another alternative embodiment, multiple databases may be stored on a single consolidated data storage device 210.

In various embodiments, the server 102 may communicate with the data storage devices 204-210 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 204-210; the server first communicating with a storage server or storage controller 106.

In one example of the system 200, the first data storage device 204 may store data associated with insurance claims made by one or more individuals. The insurance claims data may include data associated with medical services, procedures, and prescriptions utilized by the individual. In one particular embodiment, the first data storage device 202 included insurance claims data for over 56 million customers of a health insurance company. The database included claims data spanning over 14 years.

In one embodiment, the second data storage device 206 may store summary data associated with the individual (e.g., a healthcare consumer and/or provider identities). The summary data may include biographical information, an overview of the various medical examinations and procedures associated with that individual, the various prescriptions associated with that individual, and other individuals (e.g., family members) associated with that individual. Such summary data may be gleaned (e.g., automatically) from healthcare claims data or other sources.

The third data storage device 208 may further store summary data associated with medical practitioners (e.g., healthcare providers, doctors, physicians, and/or provider identities). The summary data may include biographical information and associations.

A fourth data storage device (not shown) may store links between healthcare consumers, between healthcare providers, and between healthcare consumers and healthcare providers. In some embodiments, the fourth data storage device may be referred to as a “relationship archive.” These links are discussed in more detail throughout the disclosure.

The server 102 may host a software application configured for identifying healthcare claim fraud. The software application may further include modules for interfacing with the data storage devices 204-210, interfacing a network 108, interfacing with a user, and the like. In a further embodiment, the server 102 may host an engine, application plug-in, or application programming interface (API). In another embodiment, the server 102 may host a web service or web accessible software application.

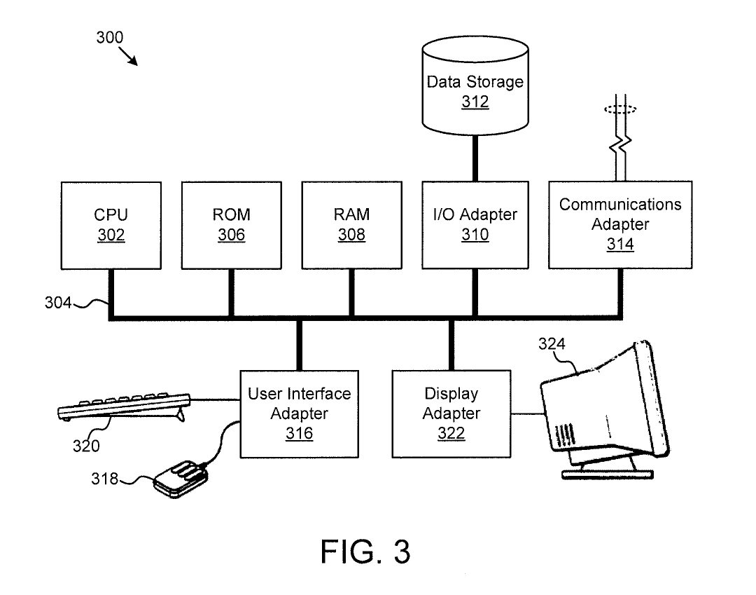

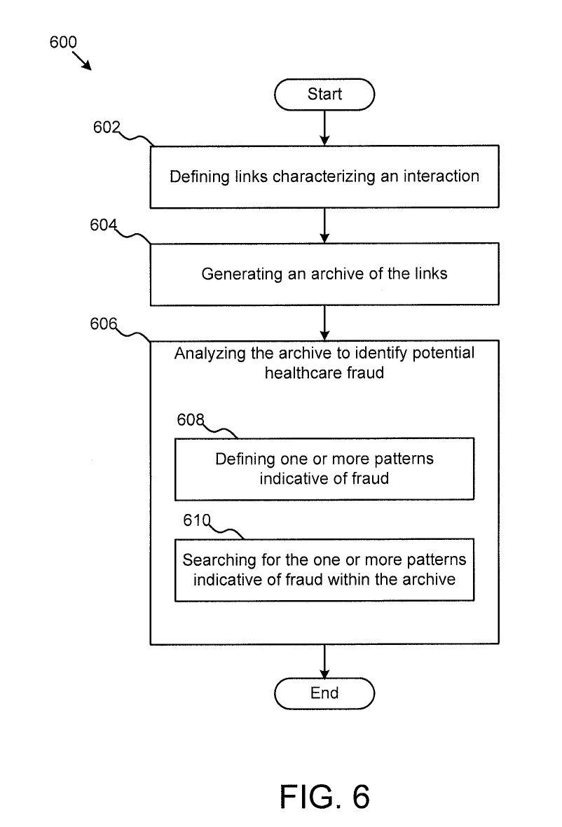

FIG. 3 illustrates a computer system 300 adapted according to certain embodiments of the server 102 and/or the user interface device 110. The central processing unit (CPU) 302 is coupled to the system bus 304. The CPU 302 may be a general purpose CPU or microprocessor. The present embodiments are not restricted by the architecture of the CPU 302, so long as the CPU 302 supports the modules and operations as described herein. The CPU 302 may execute the various logical instructions according to the present embodiments. For example, the CPU 302 may execute machine-level instructions according to the exemplary operations described below with reference to FIG. 6.

The computer system 300 also may include Random Access Memory (RAM) 308, which may be SRAM, DRAM, SDRAM, or the like. The computer system 300 may utilize RAM 308 to store the various data structures used by a software application configured to identify healthcare claim fraud. The computer system 300 may also include Read Only Memory (ROM) 306 which may be PROM, EPROM, EEPROM, optical storage, or the like. The ROM may store configuration information for booting the computer system 300. The RAM 308 and the ROM 306 hold user and system 100 data.

The computer system 300 may also include an input/output (I/O) adapter 310, a communications adapter 314, a user interface adapter 316, and a display adapter 322. The I/O adapter 310 and/or user the interface adapter 316 may, in certain embodiments, enable a user to interact with the computer system 300 in order to input information. In a further embodiment, the display adapter 322 may display a graphical user interface associated with a software or web-based application for identifying healthcare claim fraud.

The I/O adapter 310 may connect to one or more storage devices 312, such as one or more of a hard drive, a Compact Disk (CD) drive, a floppy disk drive, a tape drive, to the computer system 300. The communications adapter 314 may be adapted to couple the computer system 300 to the network 106, which may be one or more of a LAN and/or WAN, and/or the Internet. The user interface adapter 316 couples user input devices, such as a keyboard 320 and a pointing device 318, to the computer system 300. The display adapter 322 may be driven by the CPU 302 to control the display on the display device 324.

The present embodiments are not limited to the architecture of system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

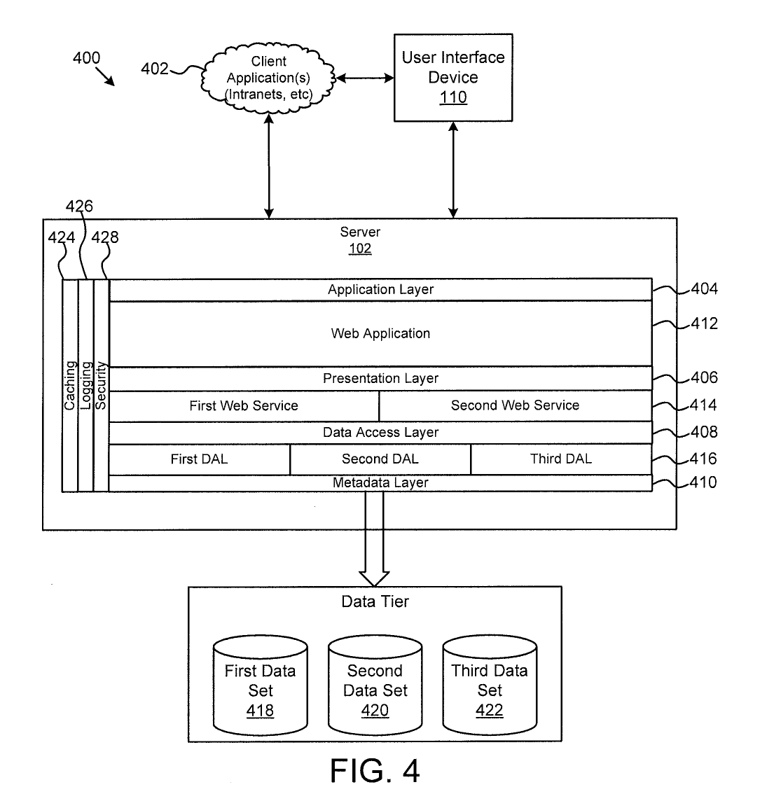

FIG. 4 illustrates one embodiment of a network-based system 400 for detecting healthcare fraud and abuse. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 422-422 that comprise a data layer or data tier. For example, a first data set 422, a second data set 420 and a third data set 422 may comprise a data tier that is stored on one or more data storage devices 204-208.

One or more web applications 412 may operate in the application layer 404. For example, a user may interact with the web application 412 though one or more I/O interfaces 318, 320 configured to interface with the web application 412 through an I/O adapter 310 that operates on the application layer. In one particular embodiment, a web application 412 may be provided for identifying potential healthcare fraud that includes software modules configured to perform the steps of defining links characterizing an interaction between a healthcare consumer and a healthcare provider, generation an archive of the links, and analyzing the archive to identify potential healthcare fraud.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414.

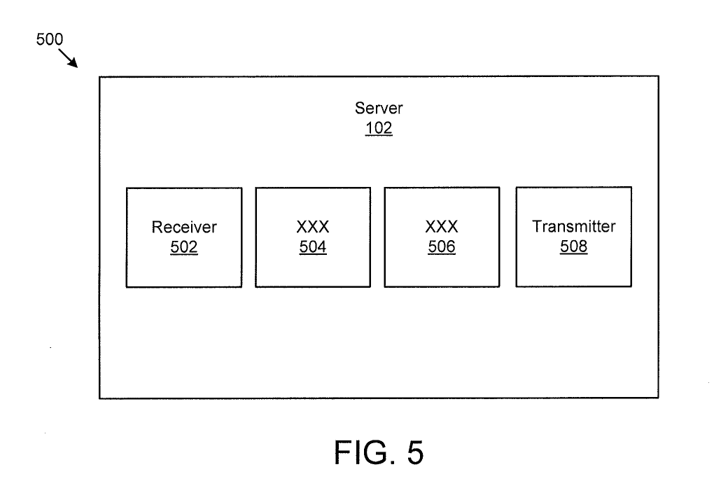

FIG. 5 illustrates a further embodiment of a system 500 for identifying healthcare claim fraud. In one embodiment, the system 500 may include a service provider site 502 and a client site 504. The service provider site 502 and the client site 504 may be separated by a geographic separation 506.

In one embodiment, the system 500 may include one or more servers 102 configured to host a software application 412 for identifying healthcare claim fraud, or one or more web services 414 for performing certain functions associated with identifying healthcare claim fraud. The system may further comprise a user interface server 508 configured to host an application or web page configured to allow a user to interact with the web application 412 or web services 414 for identifying healthcare claim fraud. In such an embodiment, a service provider may provide hardware 102 and services 414 or applications 412 for use by a client without directly interacting with the client's customers.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 6 illustrates one embodiment of a method 600 for identifying healthcare claim fraud. Embodiments of the systems previously described in this disclosure may be configured to perform one or more of the method steps of method 600. One or more modules may be defined to perform the method steps described in the various embodiments of method 600.

In one embodiment, the method 600 starts by defining 602 links characterizing an interaction. In some embodiments, a link may characterize an interaction between a healthcare consumer and a healthcare provider. Examples of healthcare consumers include, without limitation, patients, customers, and/or clients. Examples of healthcare providers include, without limitation, doctors, nurses, pharmacists, and the like. For example, if a patient visits her doctor's office, that interaction may be characterized by a link. In another example, if a patient visits a hospital and is seen by an emergency room physician and a specialist—each of those interactions may be characterized by a link. In yet another example, if a customer visits a pharmacy to collect prescription medicine from a pharmacist, that interaction may also be characterized by a link. A link may also characterize an interaction between two healthcare providers or two healthcare consumers. For example, a doctor making a referral to another doctor may be characterized by a link.

In different embodiments, links may comprise different information. In a particular embodiment, a link may at least include a first consumer-provider identity, a second consumer-provider identity, and a timestamp. For example, if patient John Doe visits Dr. Bob Smith, the first consumer-provider identity may be patient John Doe, and the second consumer-provider identity may be Dr. Bob Smith. Similarly, the first consumer-provider identity may instead be Dr. Bob Smith, and the second consumer-provider identity may be patient John Doe. As such, a “consumer-provide identity” simply captures the identity of a healthcare provider and/or healthcare consumer as described above. In some embodiments, the consumer-provider identity may include certain biographical information such as, for example, name, address, age, gender, race, and/or social security number. In some embodiments, the link may also include a timestamp. A timestamp may characterize time information associated with the link (e.g., the time and/or date of a particular interaction). For example, if a patient visits a doctor on at 12:25 PM on Dec. 12, 2010, that information may be captured in a timestamp. In some embodiments, if an interaction lasts for an extended period of time (e.g., a several day visit to a hospital), the extent of the interaction may further be included in the timestamp.

In some embodiments, provider and patient identities may be provided before the links are defined. For example, patient and provider identities may be managed in one or more databases (e.g., a patient index and a provider index). In some embodiments, each patient and provider may be identified via a unique identification number (e.g., tag and/or handle). In some embodiments, these databases may be automatically culled from claims data. Data mining patient and provider identities from claims data may include known data processing and data mining techniques such as fuzzy matching and the like. In some embodiments, the patient and provider identity databases may be updated in real-time (e.g., hourly, daily, weekly) based on incoming claims data.

In some embodiments, a link may further be characterized by a link order. As such, links may be characterized as first order, second order, third order, and/or Nth-order links (where N is an integer greater than or equal to 1). The following example helps define first, second, third, and N order links beginning with a provider A. A set of first order links may be defined characterizing each of the characterizations provider A has had with patients. If provider A has seen 100 patients, 100 first order links may be created. Moreover, a set of second order links may be created characterizing the set of providers seen by patients seen by provider A. For example, if provider A has seen a patient X, and patient X has seen a provider B, a second order may be defined characterizing these interactions. That is a second order link may defined characterizing the relationship between provider A and provider B through commonality of patient X. Similarly, a set of third order links may further be created defining the set of patients seen by providers seen by patients seen by provider A. Following this pattern, N-orders of links may be created. As is expected, the number of possible links may grow geometrically.

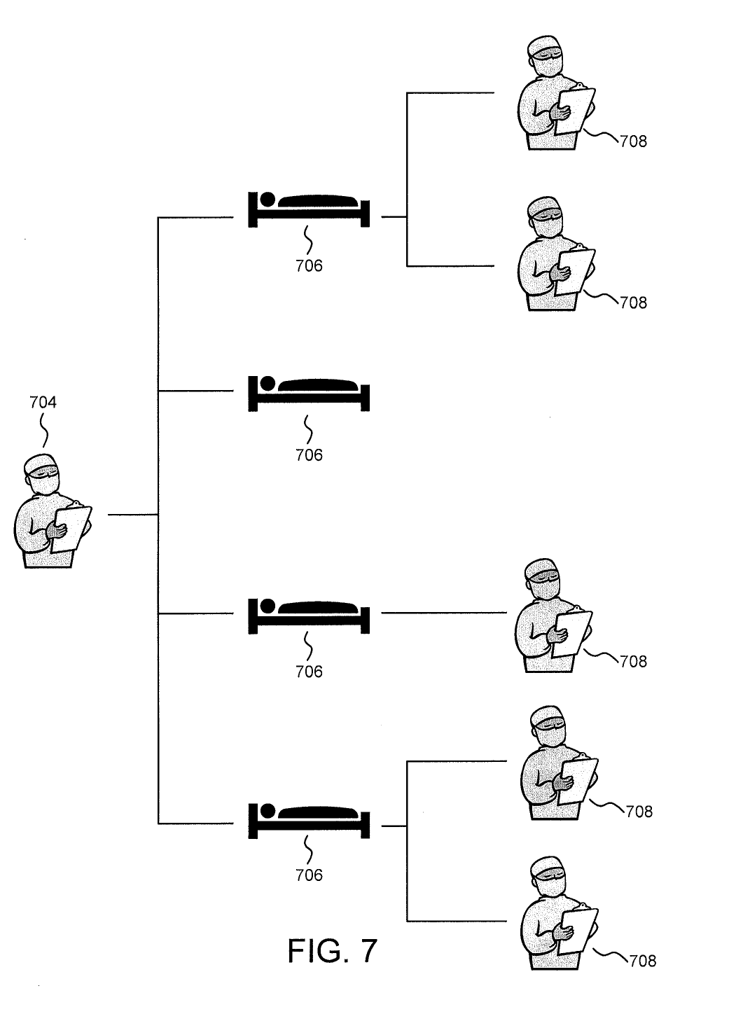

FIG. 7 illustrates a pictorial example of first and second order links. As shown first order links are defined between provider 704 and patients 706. Also as shown, some of the patients 706 additionally saw one or more additional different healthcare providers 708. Second order links are defined between provider 704 and providers 708.

In some embodiments, the method 600 continues by generating 604 an archive of links. The archive of links may also be referred to as a relationship archive. In some embodiments, the archive of links may be generated 604 based on the provided provider and patient identity databases discussed earlier. Also, as the links archive may be grow geometrically (depending on the number of orders of links generated), in some embodiments, the link archive may be calculated in real-time and stored in memory. As such, the generation of the link archive may be achieved dynamically on an as-needed basis.

Returning to FIG. 6, in some embodiments, the method 600 continues by analyzing 606 the archive of links to identify potential healthcare fraud. Analyzing 606 the archive may include defining 608 one or more patterns indicative of fraud and 610 searching for the one or more patterns indicative of fraud within the link archive. Healthcare consumers and healthcare providers that engage in healthcare fraud may follow repeatable patterns, and by analyzing the patterns generated within the link archive, these patterns can be discovered, flagged, and analyzed.

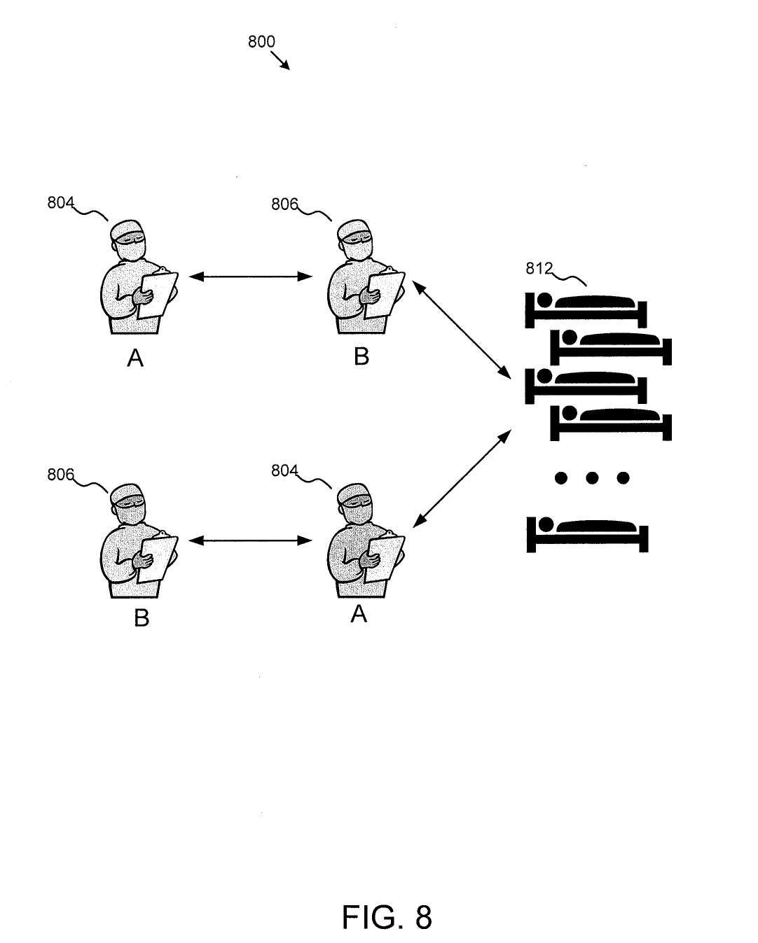

FIG. 8 illustrates one example of a pattern indicative of fraud that can be used to search the link archive. The pattern 800 may be referred to as a “referring and servicing” pattern. The set of patients 812 may be a large set of patients that could include many of the patients seen by physician 804 and physician 806. As shown in this pattern, physician 804 (Physician A) may refer some or all of the patients within the set of patients 812 to physician 806 (Physician B). Physician B may then see some or all of these patients referred to him by Physician A. At the same time, Physician B may also refer some or all of the patients within the set of patients 812 (which may include the same or a different set of patients) to Physician A, and Physician A may also treat some or all of these patients. The referring and servicing pattern attempts to find one or more providers that refer and service sets of patients between one another. Such a referring and servicing relationship could be indicative of healthcare fraud.

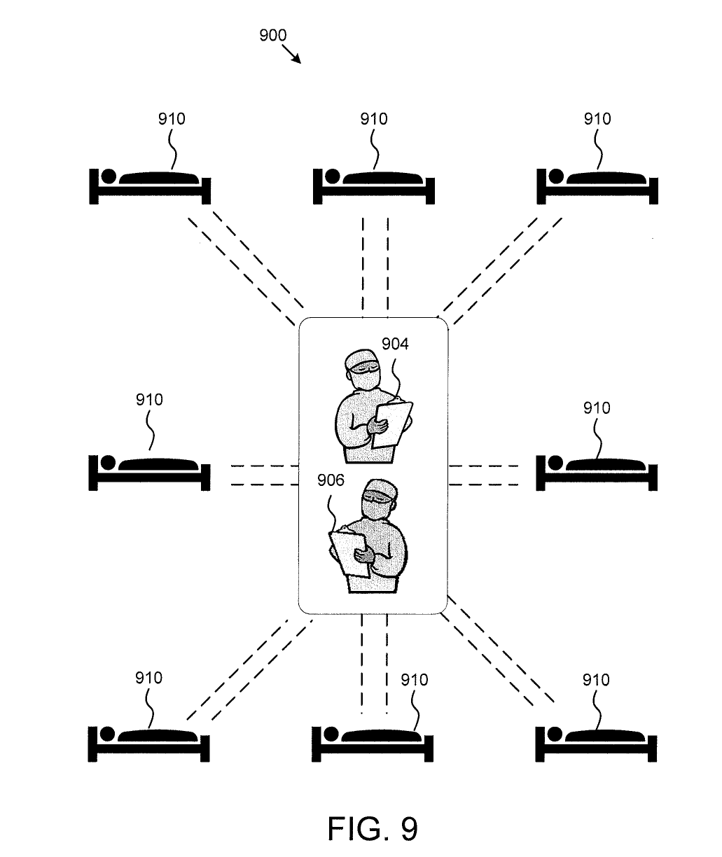

FIG. 9 illustrates an additional example of a pattern indicative of fraud that can be used to search the link archive. The pattern 900 may be referred to as a “fraud ring.” In one example of a fraud ring, physician 904 sees a set of patients 910 on one day, and physician 906 may see the same or similar set of patients 910 on a subsequent day. Largely, the fraud ring pattern attempts to find one or more healthcare providers who have interactions with the same (or similar) set of patients within a finite period of time. Such a fraud ring pattern can be determined by comparing the first and second order links (and their timestamps) of one or more physicians.

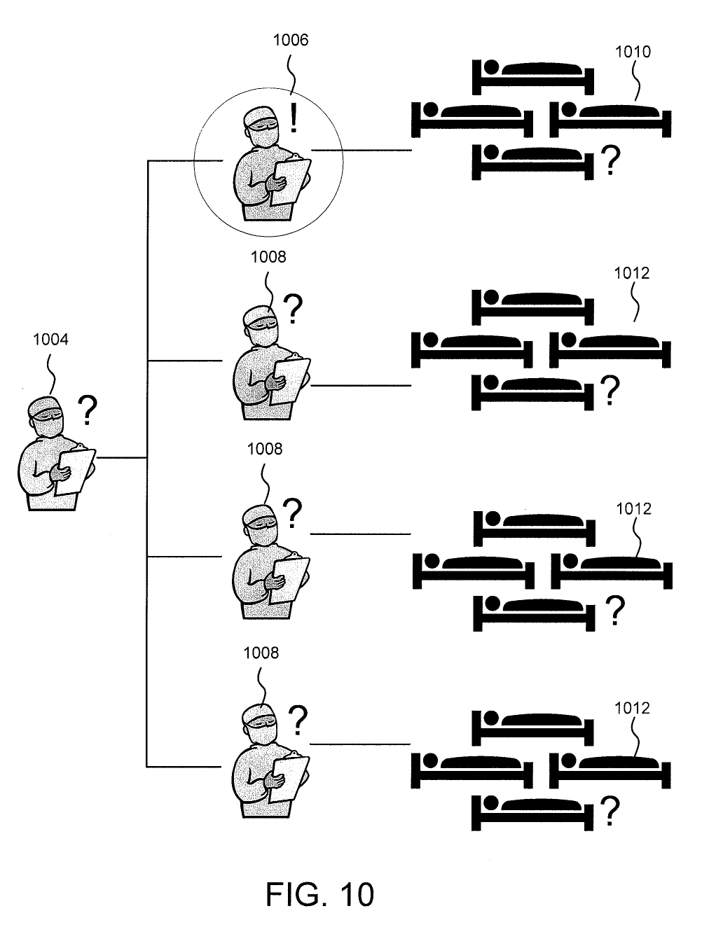

In some embodiments, analyzing the archive may further include flagging known fraudsters. Such an analysis is presented within FIG. 10. As depicted in the figure, physician 1006 is a known fraudster (e.g., this physician has been known to commit healthcare fraud). As a result, in some embodiments, once physician 1006 is flagged, analyzing the archive may further include a heightened analysis of the links associated with flagged known fraudsters. For example, as depicted, physician 1006—a known fraudster—may have links with physician 1004 and physicians 1006. Physician 1006 may also have links with the set of patients 110 and the sets of patients 112. As such one or more of the providers and/or consumers linked with physician 1006 may be placed under heightened scrutiny. Each of the links associated with the associated providers and/or consumers may be analyzed to find fraud patterns.

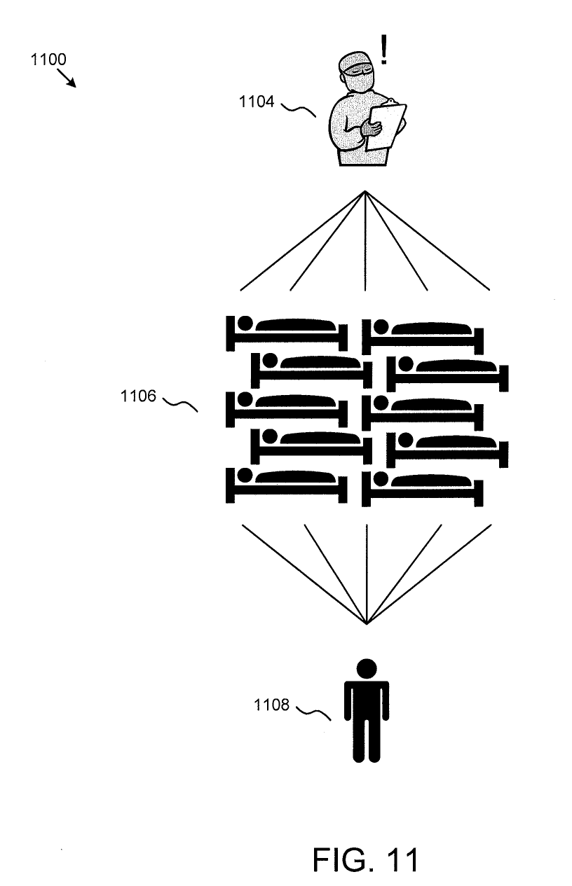

FIG. 11 provides an additional illustration of a pattern indicative of fraud that can be used to search the link archive. As shown in the figure, the pattern 1100 analyzes attempts by providers to avoid punishment after initially being detected as a known fraudster. For example, provider 1104 may previously have been identified as a known fraudster—either using the methods, systems, and apparatuses presented in this disclosure or other means. A provider that is tagged as a known fraudster may attempt to change their identity. Moreover, a known fraudster may have her healthcare claims rejected by a healthcare company, and by changing identities, the known fraudster can continue to treat patients and attempt to gain reimbursement for healthcare claims. As shown in the figure, both provider 1104 and provider 1108 are linked to the same set of consumers 1106. Such a pattern may be an indication that provider 1104 has changed his identity to provider 1106.

The patterns presented in the preceding paragraphs and presented for example only and are not intended to limit the claims. In some embodiments, one or more patterns that are used to search the relationship archive may be user-defined. Moreover, an analysis of clinical data manually or otherwise and using known data mining techniques—may reveal additional patterns indicative of fraud.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method for identifying healthcare claim fraud comprising:
defining links characterizing an interaction between a healthcare consumer and a healthcare provider;
generating, with a processing device, an archive of the links; and
analyzing the archive to identify potential healthcare fraud, where analyzing the archive comprises:
defining one or more patterns indicative of fraud; and
searching for the one or more patterns indicative of fraud within the archive.

2. The method of claim 1, where each link comprises
a first consumer-provider identity;
a second consumer-provider identity; and
a timestamp;
wherein the first consumer-provider identify is different from the second consumer-provider identity.

3. The method of claim 1, the links comprising first-order links and second-order links.

4. The method of claim 3, the links further comprising third-order links.

5. The method of claim 4, the links further comprising Nth-order links.

6. The method of claim 1, where analyzing the archive further comprises flagging known fraudsters.

7. The method of claim 6, where analyzing the archive further comprises heightened analysis of the links associated with flagged known fraudsters.

8. The method of claim 1, further comprising receiving a provider index and a patient index before defining the links.

9. The method of claim 8, where the provider index comprises provider handle keys and the patient index comprises patient handle keys.

10. The method of claim 8, where receiving the provider index and patient index further comprises fuzzy matching.

11. The method of claim 1, where the one or more patterns are user-defined.

12. The method of claim 11, where the one or more patterns are user-defined in response to clinical data.

13. A system to identify healthcare claim fraud, the system comprising a processor in communication with a memory and a data storage device where:
the memory stores processor-executable code;
the data storage device is configured to store a database comprising a patient index and a provider index; and
the processor is configured to be operable in conjunction with the processor-executable code to:
define links;
generate an archive in response to the links; and
analyze the archive to identify potential healthcare fraud, where analyzing the archive comprises:
define one or more patterns indicative of fraud; and
search for one or more patterns indicative of fraud within the archive.

14. The system of claim 13, where each link comprises
a first consumer-provider identity;
a second consumer-provider identity; and
a timestamp;
wherein the first consumer-provider identify is different from the second consumer-provider identity.

15. The system of claim 13, the links comprising first-order links and second-order links.

16. The system of claim 15, the links further comprising third-order links.

17. The system of claim 16, the links further comprising Nth-order links.

18. The system of claim 13, where analyzing the archive further comprises flagging known fraudsters.

19. The system of claim 18, where analyzing the archive further comprises heightened analysis of the links associated with flagged known fraudsters.

20. The system of claim 13, where the provider index comprises provider handle keys and the patient index comprises patient handle keys.

21. The system of claim 13, where the one or more patterns are user-defined.

22. The system of claim 21, where the one or more patterns are user-defined in response to clinical data.

23. A non-transitory computer readable-medium comprising computer-usable program code executable to perform operations comprising:
defining links;
generating an archive in response to the links; and
analyzing the archive to identify potential healthcare fraud, where analyzing the archive comprises:
defining one or more patterns indicative of fraud; and
searching for one or more patterns indicative of fraud within the archive.
